(19) United States
(12) Patent Application Publication
(10) Pub. No.: US 2024/0022465 A1
(43) Pub. Date: Jan. 18, 2024

(54) ROAMING ASPECTS FOR NETWORK DATA ANALYTICS FUNCTIONS

(71) Applicant: Nokia Technologies Oy, Espoo (FI)

(72) Inventors: Saurabh KHARE, Bangalore (IN); Yannick LAIR, Massy (FR); Shubhranshu SINGH, Munich (DE); Anja JERICHOW, Munich (DE)

(21) Appl. No.: 18/256,880

(22) PCT Filed: Dec. 10, 2020
(86) PCT No.: PCT/EP2020/085401

§ 371 Date: Jun. 9, 2023

(51) Int. Cl. H04L 41/042; H04L 41/28

(52) U.S. Cl. CPC H04L 41/042; H04L 41/28

(57) ABSTRACT

A method of performing a data retrieval service for a first analytics function of a first communication network comprises collecting (S201), for at least one user equipment, data from the first communication network, obtaining (S203), from the collected data, processed information which is to be passed to an entity of a second communication network, and storing (S205) the processed information, wherein the processed information complies with one or more protection policies with respect to the second communication network.

### TECHNICAL FIELD

At least some example embodiments are directed to roaming aspects for network data analytics functions (NWDAFs).

### BACKGROUND

A network data analytics function (NWDAF) calculates analytics based on data collected from different data sources in a communication network, such as AMF, SMF, PCF, UDM, AF, and OAM. The NWDAF offers analytics identified by a 3GPP defined analytics identifier to consumers using a services based architecture defined for 5GC, for example.

### LIST OF ABBREVIATIONS

3GPP Third Generation Partnership Project
5GC Fifth Generation Core Network
AF Application Function
AMF Access and Mobility Management Function
API Application Programming Interface
DCCF Data Collection Coordination Function
eNA enablers for Network Automation
FQDN Fully Qualified Domain Name
IP Internet Protocol
NAS Non-Access Stratum
NEF Network Exposure Function
NF Network Function
NRF Network Repository Function
NWDAF Network Data Analytics Function
OAM Operation Administration and Maintenance
PCF Policy Control Function
PLMN Public Land Mobile Network
SBA Service Based Architecture
SBI Service Based Interface
SEPP Security Edge Protection Proxy
SMF Session Management Function
SUPI Subscription Permanent Identifier
TAI Tracking Area Identity
UDM Unified Data Management
UDR Unified Data Repository
UE User Equipment
URI Unified Resource Identifier
VPLMN Virtual PLMN

### SUMMARY

At least some example embodiments address roaming aspects for a network data analytics function (NWDAF).

At least some example embodiments provide for apparatuses, methods and non-transitory computer-readable media as specified by the appended claims.

At least some example embodiments provide for a data retrieval service which collects data from a communication network and obtains processed information from the collected data, wherein the processed information complies with one or more protection policies with respect to another communication network.

According to at least some example embodiments, a new service (also referred to as NWDAF service, Nnwdaf_DataRetrieval service, data retrieval service or proxy service) is defined, which is used by NWDAF or other Network Functions to retrieve data in case of roaming scenarios and which provides proxy like function to audit whatever data is shared with another PLMN. This new service collects data from different NFs, data centers, etc., stores contents and abstracts data by anonymizing the content before passing the same information to another PLMN's NWDAF or NF.

According to at least some example embodiments, the above-mentioned data retrieval service is implemented as a new service in an NWDAF or in other NFs (e.g. AMF, SMF, . . . ) or as a new NF.

According to at least some alternative example embodiments, NWDAF based data abstraction in a roaming use case is provided, which fulfills different security and regulatory requirements.

In the following, example embodiments will be described with reference to the accompanying drawings.

### BRIEF DESCRIPTION OF THE DRAWINGS

FIG. 1 shows a diagram illustrating scenarios according to at least some example embodiments.

FIG. 2 shows a flowchart illustrating a first process for a data retrieval service according to at least some example embodiments.

FIG. 3 shows a flowchart illustrating a second process for a data retrieval service according to at least some example embodiments.

FIG. 4 shows a diagram illustrating an example implementation of a data retrieval service according to at least some example embodiments.

FIG. 5 shows a diagram illustrating an example implementation of a data retrieval service according to at least some example embodiments.

FIG. 6 shows a signaling diagram illustrating a call flow for realizing a data retrieval service according to at least some example embodiments.

FIG. 7 shows a diagram illustrating an example implementation of a data retrieval service according to at least some example embodiments.

FIG. 8 shows a schematic block diagram illustrating a configuration of a control unit in which at least some example embodiments are implementable.

### DESCRIPTION OF THE EMBODIMENTS

Before descripting some example embodiments, roaming aspects, and authorization and data manipulation between communication networks will be examined.

If a UE, from a communication network, e.g. PLMN1, is roaming in another communication network, e.g. VPLMN (PLMN2), then for UE specific analytics, NWDAF of PLMN1 has to collect data from VPLMN (PLMN2) network.

For example, there are two options for PLMN1 NWDAF to collect data from PLMN2:
Option 1: PLMN1 NWDAF may retrieve the data from one or more PLMN2 NFs, e.g. the PLMN1 NWDAF may retrieve the data directly from one or more PLMN2 NFs.
Option 2: PLMN1 NWDAF may consume analytics from PLMN2 NWDAF if agreement between PLMN 1 and PLMN 2 allows.

In addition, there can be other scenarios where PLMN2 NWDAF consumes “UE behavior like” analytics from PLMN1 NFs to improve the service in the roaming scenario.

According to NRF level authorization, NRF allows OAuth2.0 framework where authorized VPLMN NFs or NWDAFs are allowed to access services from home PLMN NFs or NWDAF and their respective services. In other words, limited services of NFs/NWDAF are exposed to VPLMN NFs. Therefore, if desired, data access for another PLMN NWDAF can be restricted.

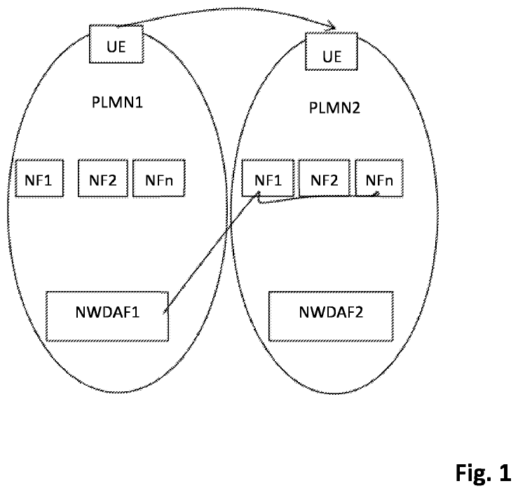

Now referring to FIG. 1, when a UE is moving from PLMN1 to PLMN2, there are two possible inter-PLMN scenarios where NWDAF or NF of a PLMN collects data from another PLMN's NF(s).

According to a first scenario, PLMN1 NWDAF1 is performing UE based analytics and UE is moving or registered in a different PLMN (PLMN2).

According to a second scenario, PLMN2 NWDAF2 can collect data from PLMN1 NFs to enhance user experience during roaming.

In case of inter-PLMN movement (i.e. roaming), data collection via different NFs (e.g. via messages “Subscribe”/“Notify”) is expected to bring about the following issues:
There are different security and regulatory indications or requirements for PLMN1 and PLMN2, like what kind of data to be shared, what kind of data to be restricted. For example, every TAI change in AMF of PLMN2 should not be shared with PLMN1 and vice versa.
Data anonymization before passing data to the other PLMN should be applied. For example, if a UE is attached in a restricted area (TAI), then any TAI change should be reported as generic TAI configured in the communication network.
Data shared with the other PLMN should be stored for audits. For example, data shared by an SMF of PLMN2 to PLMN1 NWDAF1, that may be used for auditing should be stored.

According to at least some example embodiments, the above issues are addressed by a data retrieval service for an analytics function of a communication network, e.g. 5GC.

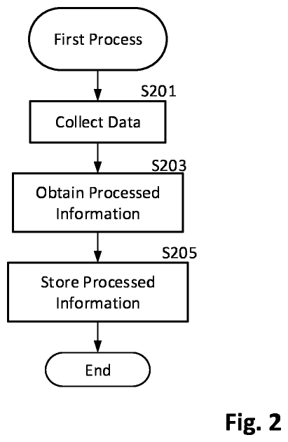

FIG. 2 shows a flowchart illustrating a first process for a data retrieval service according to at least some example embodiments. For example, the first process is implemented by at least one of an NWDAF, an NF or a proxy of a communication network. For example, referring to FIG. 1, at least one of NWDAF1, NWDAF2, NF1 . . . NFn of PLMN1, NF1 . . . NFn of PLMN2, proxy (not shown) of PLMN1 and proxy (not shown) of PLMN2 is configured to perform the first process.

In step S201 of FIG. 2, for at least one user equipment (e.g. UE of FIG. 1), data is collected from a communication network which the entity belongs to that performs the first process. Assuming that the UE of FIG. 1 is roaming in PLMN2, NWDAF2 or any one of NF1 . . . NFn or a proxy (not shown in FIG. 1) of PLMN2 performs the first process. In the following, PLMN2 will also be referred to as “first communication network”. Then, the first process proceeds to step S203 of FIG. 2.

In step S203, from the collected data, processed information is obtained, which is to be passed to an entity of another communication network (referred to in the following as “second communication network”) (PLMN1 in the example of FIG. 1). The entity of the second communication network comprises NWDAF1 or any one of NF1 . . . NFn or a proxy (not shown in FIG. 1) of PLMN1.

The processed information complies with one or more protection policies with respect to the second communication network. According to at least some example embodiments, the entity performing the first process processes the collected data to obtain the processed information. Then, the first process proceeds to step S205. According to at least some example embodiments, the protection policies are specific to the first communication network (e.g. operator decided policies), that need to be applied to the collected data e.g. before passing the thus obtained processed information to the second communication network.

In step S205, the processed information is stored, e.g. for later use. Then the first process ends. According to at least some example embodiments, the entity performing the first process comprises a data storage entity storing the processed information persistently.

According to at least some example embodiments, the first process is performed in response to a request, e.g. upon receiving a request, from the entity of the second communication network (PLMN1 in the example of FIG. 1).

According to at least some example embodiments, the processed information is obtained by at least one process out of the following processes: pre-processing content of the collected data; aggregating content of the collected data; applying one or more protection policies with respect to the second communication network to content of the collected data; filtering content of the collected data; anonymizing content of the collected data; restricting content of the collected data; and blocking the collected data.

According to at least some example embodiments, the one or more protection policies are associated with at least one of a type of a network function of the second communication network and an identity of the second communication network.

According to at least some example embodiments, in the first process, after step S203 or S205, the processed information is transmitted to the entity of the second communication network.

According to at least some example embodiments, step S201 comprises at least one out of the following: accessing the data from network functions of the first communication network, e.g. AMF(s), SMF(s); accessing the data from an operation, administration and maintenance entity of the first communication network; accessing the data from application functions of the first communication network; accessing the data from data collection coordination functions of the first communication network; accessing the data from data lakes or external storage of the first communication network; and accessing the data from one or more user equipments served by the first communication network.

According to at least some example embodiments, step S201 comprises at least one of: subscribing to at least one network function of the first communication network; and contacting at least one network function of the first communication network.

According to at least some example embodiments, the at least one user equipment comprises at least one out of the following: one or more user equipments that are visiting the first communication network; and one or more user equipments of a specific communication network.

According to at least some example embodiments, the entity performing the data retrieval service is registered in an authorization entity of the first communication network, e.g. an NRF. According to at least some example embodiments, the authorization entity indicates to the entity of the second communication network to direct or send a request for collecting, for at least one user equipment, data from the first communication network, to the data retrieval service entity.

According to at least some example embodiments, the registering comprises indicating events which are supported by the data retrieval service.

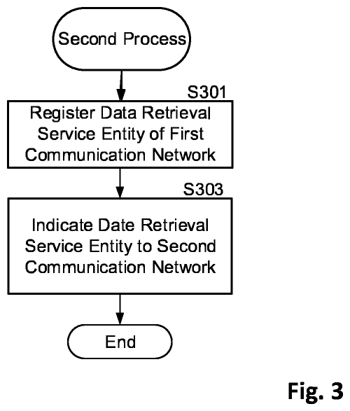

In this context, FIG. 3 shows a flowchart illustrating a second process for a data retrieval service according to at least some example embodiments. For example, the second process is performed by an authorization entity, e.g. an NRF, of a communication network.

In step S301, a data retrieval service entity of a communication network (referred to in the following as “first communication network”) is registered, which performs a data retrieval service for an analytics function (referred to in the following as “first analytics function”) of the first communication network, e.g. the first process shown in FIG. 2. Then, the second process proceeds to step S303.

In step S303, the authorization entity indicates to an entity of another communication network (referred to in the following as “second communication network”) to direct or send a request for collecting, for at least one user equipment, data from the first communication network, to the data retrieval service entity. Then the second process ends.

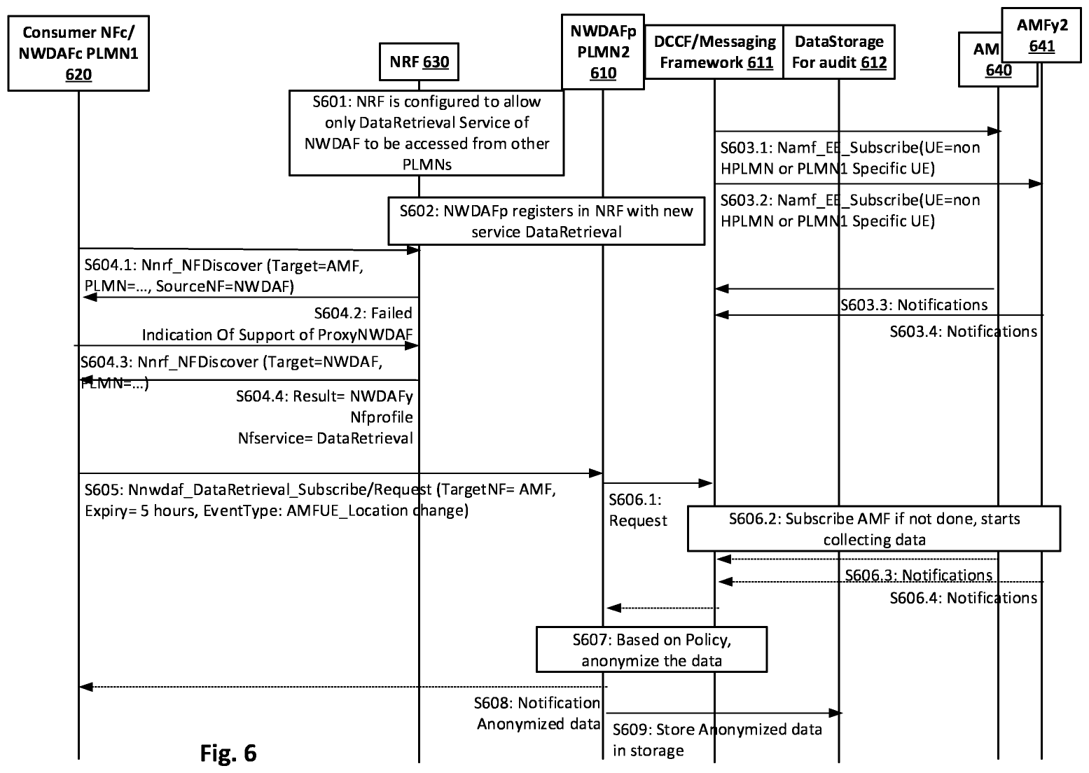

According to an example implementation, the second process is implemented by an NRF 630 shown in FIG. 6 performing some or all of steps S602, S604.1, S604.2, S604.3 and S604.4 of FIG. 6.

As described above, several options of inter-PLMN scenarios are provided that allow one PLMN (NWDAF, NF, proxy of the PLMN) to access data from another PLMN's NF supporting e.g. anonymization, restricted access, and auditing requirements. According to at least some example embodiments, the first process for the data retrieval service is implemented in the NWDAF. According to at least some alternative example embodiments, the first process for the data retrieval service is implemented in each NF itself, or a standalone NF/proxy in the communication network implements the first process for the data retrieval service.

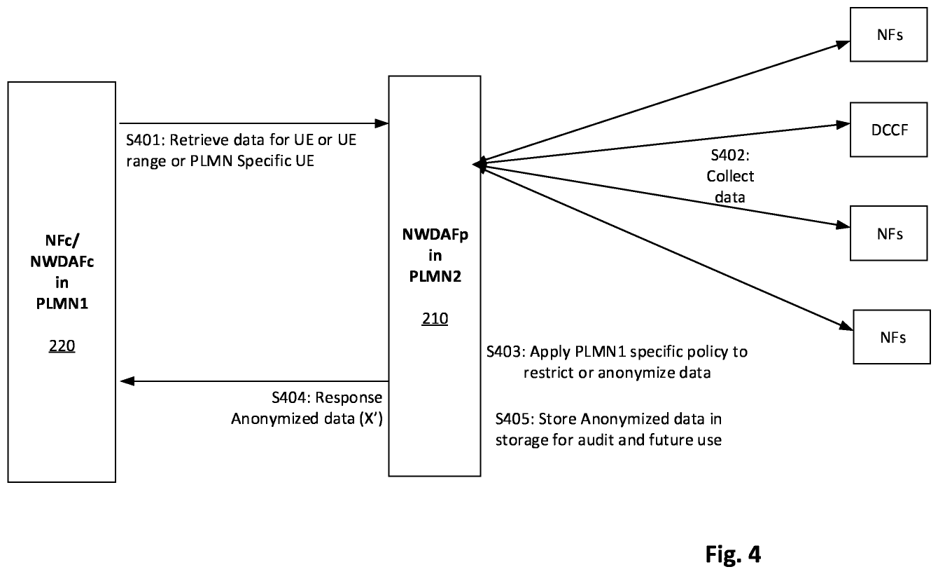

Now reference is made to FIG. 4 which shows a diagram illustrating an example implementation of the data retrieval service according to at least some example embodiments.

In step S401, an NWDAFc and/or NFc 220 of PLMN1 (also referred to as “second communication network” in this specification) discovers an NWDAFp 210 of PLMN2 (also referred to as “first communication network” in this specification).

According to at least some example embodiments, the NFc/NWDAFc 220 of PLMN1 requests data collection via NWDAFp data retrieval service. For example, NWDAFc and/or NFc 220 uses Nnwdaf_DataRetrieval service for this purpose. According to at least some example embodiments, data is retrieved for a UE or for a UE range or for a PLMN specific UE.

In step S402, in response to, for instance upon receiving, an Nnwdaf_DataRetrieval service request from NWDAFc and/or NFc 220, NWDAFp 210 collects data from different NFs/DCCF for a specific UE or group of UE or PLMN Specific UE, which will be explained in more detail later on.

In step S403, after collecting the data in step 402, and/or, if required, generating analytics output, NWDAFp 210 applies PLMN1 specific policies and anonymizes or restricts the collected data.

In step S404, NWDAFp 210 sends the processed data (also referred to as “processed information” in this specification) to NWDAFc/NFc 220 as a response to the Nnwdaf_DataRetrieval service request.

In step S405, NWDAFp 210 stores filtered and anonymized data (also referred to as “processed information” in this specification) for possible future uses e.g. for the purposes of audition. This is useful for regulatory requirements, where the data which is shared with other PLMNs is used for further analysis. For example, the processed information is stored by the NWDAFp 210 for 2 months which may be used for auditing.

In the following, a use case/an example of an audit data requirement will be described.

A UE from PLMN1 roams in PLMN2. NWDAFc of PLMN1 collects data from PLMN2 NF. Based on collected data, NWDAFc has provided some services to UE. As NWDAFc has storage capabilities, it can store the data collected from PLMN2 for months. At a later point of time, an operator or enterprise of PLMN1 can put a claim on provided data (e.g. provided data is not correct or provided data is having some issue). Therefore, PLMN2 NWDAF has to store the data for audits.

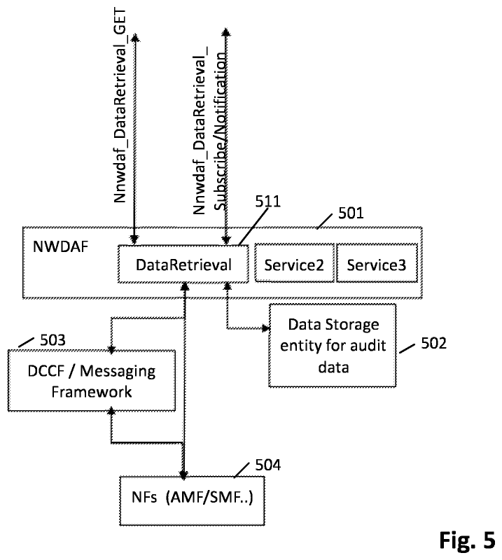

To achieve the above-defined behavior, according to at least some example embodiments, a specific data retrieval service (e.g. corresponding to the first process shown in FIG. 2) is defined in NWDAF, as illustrated in FIG. 5.

As shown in FIG. 5, NWDAF 501, besides other services indicated in FIG. 5 as “Service2”, “Service3”, comprises a service 511 “DataRetrieval”, which provides two APIs to retrieve data, one is based on request/response model (Nnwdaf_DataRetrieval_GET) and another is based on Subscribe/Notify model (N nwdaf_DataRetrieval_Subscribe/Notification).

This service 511 provides policy configuration per PLMN and NF type to anonymize or restrict data collected from NFs 504 or service/entity 503 e.g. DCCF or data lake or external storage.

For example, regarding [PLMN1, NWDAF], TAI information has to be anonymized.

For example, regarding [PLMN2, AF], a notification for a restricted area “TAI1, TAI2..” will not be sent.

According to at least some example embodiments, for the service 511 “DataRetrieval” of NWDAF 501 a data storage entity 502 is provided, having persistent data storage capability where data, e.g. processed information, is stored for future audits. For example, the data storage entity 502 stores data which the service “DataRetrieval” 511 shares with other NFs after applying PLMN/NF specific rules. For example, the data storage entity 502 is used for further data retrieval or historical data.

According to at least some example embodiments, the NWDAF-DataRetrieval service 511 accesses data from different NFs 504 or service/entity 503, e.g. DCCF or data lake or external storage.

According to at least some example embodiments, NWDAF 501 registers in NRF (not shown in FIG. 5) with Nfprofile having additional information so that different other PLMN's NFs/NWDAF can consume the service 511 “Nnwdaf_DataRetrieval”. For example, the NWDAF 501 registers using “Nfservice: Nnwdaf_DataRetrieval” and “SupportingNFForDataRetrieval: AMF (LocRetrieval, AreaoFlnterest), SMF(..)”.

According to at least some example embodiments, the NWDAF-DataRetrieval service 511 also performs some pre-processing of the collected data, or aggregation of the collected data.

Referring to FIG. 1, NWDAF1 of PLMN1 discovers NWDAF2 of PLMN2, based on operator policy/Oauth2.0 security, where NWDAF1 is allowed to access only NWDAF2-Data Retrieval service, e.g. service 511 shown in FIG. 5.

Now reference is made to FIG. 6 which illustrates a call flow for realizing a data retrieval service according to at least some example embodiments.

In FIG. 6, NWDAFp 610 or DCCF 611 or data storage 612 (audit) are shown as a separate box. However, there is no limitation to this configuration. For example, depending on particular deployment options, NWDAFp 610, DCCF (also includes messaging framework) 611 and data storage 612 are seen as a single box with their functionalities.

According to at least some alternative example embodiments, the data storage 612 is realized as a part of NWDAFp 610 or DCCF 611 or as proprietary deployment. For simplification only, the data storage 612 is considered as a part of NWDAFp 610.

In step S601, based on an operator policy, NRF 630 defines Oauth2.0 framework where other PLMNs' NWDAF or NFs cannot retrieve data from services of AMF/SMF.

In step S602, NWDAFp 610 of PLMN2, which supports a data retrieval service (e.g. the first process shown in FIG. 2) according to at least some example embodiments, and provides a proxy like function, registers in the NRF 630 with the service “Data Retrieval”. For example, NWDAF Nfservice used for registering in NRF also comprises additional information on supporting NFs and events:
Nfservice: Nnwdaf_DataRetrieval
   SupportingNFForDataRetrieval:
      AMF (Event=LocRetrieval, Event=Area of Interest)
      SMF ( . . . )

SupportingNFForDataRetrieval attribute of NfService defines some or all proxy events supported by the data retrieval service.

As shown in FIG. 6, in steps S603.1-4, UE types are defined which are used in a Subscribe request towards AMF/SMF/NF, e.g. AMFy1 640, AMFy2 641.

For example, a UE type comprises non-HPLMN UEs which include any UE which is not from home PLMN (PLMN2 in the present example).

For example, a UE type comprises PLMN specific UEs which include any UE which is from a specific PLMN (e.g. using MCC/MNC based SUPI/IMSI).

NWDAFp 610 and/or DCCF 611 perform(s) data collection from different NFs in advance if required via a filter in the Subscribe request towards AMF/SMF, as illustrated in steps S603.1, S603.2. Considering roaming traffic is always less, NWDAFp 610 and/or DCCF 611 may collect data from some or all AMFs/SMFs (e.g. AMFy1 640, AMFy2 641) via the defined UE type.

In steps S604.1-4, when PLMN1 NWDAFc/NFc 620 collects data from PLMN2 AMF/SMF, it performs Nnrf_NFDiscover to retrieve AMF/SMF endpoints. NRF 630 rejects the request and indicates the data retrieval service (proxy service) of NWDAFp 610 (step S604.2). To indicate this, for example, an SBI error code is defined or problem-details are packed. This indication can be used by the other PLMN/country NWDAF/NF (e.g. consumer NFc/NWDAFc 620 of PLMN1 in FIG. 6) to discover NWDAF Proxy (data retrieval service) (steps S604.3, S604.4). For example, the indication also provides an address of the NWDAF performing the data retrieval service.

Alternatively, NWDAFc/NFcs 620 of PLMN1 know(s) that PLMN2 provides data via proxy or data retrieval service (e.g. according to an agreement between the operators), so the NWDAFc/NFcs 620 requests data, e.g. directly, via the data retrieval service.

In step S605, when endpoints are received from NRF 630 (or are known), the PLMN1 NWDAFc or NFc 620 invokes Nnwdaf_DataRetrieval_Subscribe/Request.

This API provides one or more of the following IEs:

```
TargetNFType= AMF/SMF
UE= SUPI or Group of SUPI
EventSpecificInformation{
  NF: AMF
  Event= Location Retrieval
  Expiry=duration e.g. 5 hours
  Etc..
  }
```

In step S606.1-4, based on the request, NWDAFp 610 (i.e. the data retrieval service) subscribes to the AMF(s) (AMFy1 640, AMFy2 641), if it has not done so before in steps S603.1-4, and starts collecting notifications.

For example, as NWDAFp 610 does not know the location of the UE (specific AMF) for which data has to be collected, it subscribes to some or all AMFs using PLMN1 specific filter. Alternatively, NWDAFp 610 collects information to which AMF to subscribe from UDM of PLMN1 via Nudm_UECM_Get (AMF data).

In step S607, NWDAFp 610 applies policies (e.g. protection policies) per source PLMN (PLMN1), source NFType, destination NFType, etc.. After applying the policies, for example, NWDAFp 610 decides to anonymize the collected data or suppress one or more of the notifications.

In step S608, after processing, if processed data (also referred to as “processed information” in this specification) needs to be shared, then NWDAFp 610 sends a notification to PLM NFc or NWDAFc 620.

In step S609, NWDAFp 610 also stores the processed data into the data storage 612.

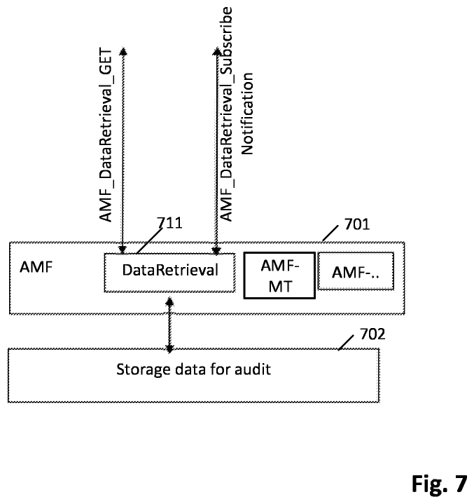

Now reference is made to FIG. 7 which illustrates another example implementation of a data retrieval service according to at least some example embodiments.

The example implementation shown in FIG. 7 is a variant of example implementations illustrated in FIGS. 4-6. In the example implementation of FIG. 7, each NF provides the data retrieval (or proxy) service according to at least some example embodiments to access data from different PLMNs. For example, as described above, the data retrieval service (e.g. first process shown in FIG. 2) anonymizes content of collected data before passing the processed information to another PLMN's NWDAF/NF.

As shown in FIG. 7, an AMF 701 comprises service 711 “DataRetrieval”, besides further services such as AMF-MT, AMF- . . . . For example, service 711 corresponds to the first process as illustrated in FIG. 2.

In case another PLMN's (e.g. PLMN1's) NWDAF/NF requests data from the AMF 701, an NRF (not shown in FIG. 7) exposes service 711 only, while other AMF services such as AMF_EventExposure services are not exposed.

As shown in FIG. 7, service 711 has connectivity with external Audit storage 702 to store the anonymized content (also referred to as “processed information” in this specification).

The service 711 also provides two APIs to retrieve data, one is based on request/response model (Nnwdaf_DataRetrieval_GET) and another is based on Subscribe/Notify model (Nnwdaf_Data Retrieval_Subscribe/Notification).

According to a further example implementation, the proxy like service or data retrieval service according to at least some example embodiments is implemented as a new NF. For example, this new NF collects data from different NFs, data centers, and stores content of the collected data, and anonymizes the content before passing the thus obtained processed information to the other PLMN's NWDAF/NF.

Use cases where the data retrieval service according to at least some example embodiments is useful comprise at least one out of the following:
UE from PLMN1 visits in PLMN2. PLMN1 asks reports from PLMN2's NWDAFs/NFs. NWDAFs/NFs of PLMN2 provided reports did not go well in PLMN1, so operator disputes may occur. PLMN1 might be storing the data received from PLMN2, therefore, by storing the processed information, PLMN2 also has some proof available for audits.
Hiding TAI changes (due to UE mobility) information to PLMN1 where TAI is from restricted areas.
Hiding unexpected UE behavior because of some downlink sessions which are provided by PLMN2 to UE. For example, PLMN2 wants to send some advertising calls/SMS service to UE, which PLMN2 does not want to expose to PLMN1.
Hiding radio coverage fluctuations: A UE may re-select between neighbor cells due to radio coverage fluctuations. While this may be useful to know for NFs within PLMN2, this should not be indicated to PLMN1 NF or NWDAF.

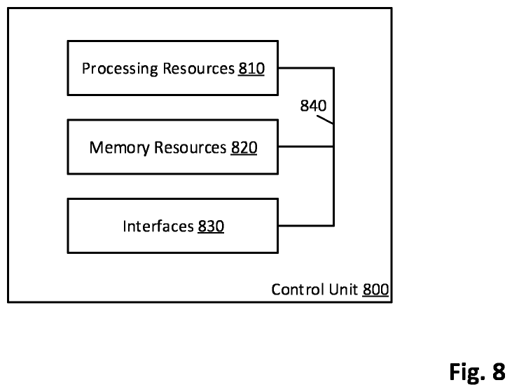

Now reference is made to FIG. 8 illustrating a simplified block diagram of a control unit 800 that is suitable for use in practicing at least some example embodiments. According to an example implementation, the method of FIG. 2 is implemented by the control unit 800. According to another example implementation, the method of FIG. 3 is implemented by the control unit 800.

The control unit 800 comprises processing resources (e.g. processing circuitry) 810, memory resources (e.g. memory circuitry) 820 and interfaces (e.g. interface circuitry) 830, which are coupled via a wired or wireless connection 840.

Further, as used in this application, the term “circuitry” refers to one or more or all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

According to an example implementation, the memory resources 820 are of any type suitable to the local technical environment and are implemented using any suitable data storage technology, such as semiconductor based memory devices, magnetic memory devices and systems, optical memory devices and systems, fixed memory and removable memory. The processing resources 810 are of any type suitable to the local technical environment, and include one or more of general purpose computers, special purpose computers, microprocessors, digital signal processors (DSPs) and processors based on a multi core processor architecture, as non limiting examples.

According to an example implementation, the memory resources 820 comprise one or more non-transitory computer-readable storage media which store one or more programs that when executed by the processing resources 810 cause the control unit 800 to function as data retrieval service as described above.

In general, at least some example embodiments are implemented in hardware or special purpose circuits, software (computer readable instructions embodied on a computer readable medium), logic or any combination thereof.

According to at least some example embodiments, an apparatus for performing a data retrieval service for a first analytics function of a first communication network is provided. The apparatus comprises means for collecting, for at least one user equipment, data from the first communication network, means for obtaining, from the collected data, processed information which is to be passed to an entity of a second communication network, and means for storing the processed information, wherein the processed information complies with one or more protection policies with respect to the second communication network.

According to at least some example embodiments, the data is collected in response to a request, e.g. upon receiving a request, from the entity of the second communication network.

According to at least some example embodiments, the means for obtaining the processed information comprises at least one out of the following:
means for pre-processing content of the collected data;
means for aggregating content of the collected data;
means for applying one or more protection policies with respect to the second communication network to content of the collected data;
means for filtering content of the collected data;
means for anonymizing content of the collected data;
means for restricting content of the collected data; and
means for blocking the collected data.

According to at least some example embodiments, the one or more protection policies are associated with at least one of a type of a network function of the second communication network, a type of a network function of the first communication network, an identity of the first communication network, and an identity of the second communication network.

According to at least some example embodiments, the apparatus further comprises means for transmitting the processed information to the entity of the second communication network.

According to at least some example embodiments, the means for collecting the data comprises at least one out of the following:
means for accessing the data from network functions of the first communication network;
means for accessing the data from an operation, administration and maintenance entity of the first communication network;
means for accessing the data from application functions of the first communication network;
means for accessing the data from data collection coordination functions of the first communication network;
means for accessing the data from data lakes or external storage of the first communication network; and
means for accessing the data from one or more user equipments served by the first communication network.

According to at least some example embodiments, the apparatus further comprise means for registering the apparatus, as performing the data retrieval service, in an authorization entity of the first communication network, wherein the authorization entity indicates to the entity of the second communication network to direct or send a request for collecting, for at least one user equipment, data from the first communication network, to the apparatus.

According to at least some example embodiments, the means for registering comprises means for indicating events which are supported by the data retrieval service.

According to at least some example embodiments, the at least one user equipment comprises at least one out of the following:
one or more user equipments that are visiting the first communication network; and
one or more user equipments of a specific communication network.

According to at least some example embodiments, the means for collecting the data comprises at least one of:
means for subscribing to at least one network function of the first communication network; and
means for contacting at least one network function of the first communication network.

According to at least some example embodiments, the apparatus is part of an entity of the first communication network, which implements the first analytics function.

According to at least some alternative example embodiments, the apparatus is part of at least one entity of the first communication network, which implements at least one of network function and proxy function.

According to at least some example embodiments, the apparatus is implemented by resources of the control unit 800 of FIG. 8.

According to at least some example embodiments, an apparatus is provided which comprises means for registering a data retrieval service entity of a first communication network, which performs a data retrieval service for a first analytics function of the first communication network, and means for indicating to an entity of a second communication network to direct or send a request for collecting, for at least one user equipment, data from the first communication network, to the data retrieval service entity.

According to at least some example embodiments, the apparatus is implemented by resources of the control unit 800 of FIG. 8.

It is to be understood that the above description is illustrative and is not to be construed as limiting the disclosure. Various modifications and applications may occur to those skilled in the art without departing from the true spirit and scope of the disclosure as defined by the appended claims.

1. An apparatus for performing a data retrieval service for a first analytics function of a first communication network, the apparatus comprising at least one processor and at least one memory including computer program code, the at least one memory and the computer program code configured to, with the at least one processor, cause the apparatus at least to perform:
collecting, for at least one user equipment, data from the first communication network;
obtaining, from the data, processed information which is to be passed to an entity of a second communication network; and
storing the processed information,
wherein the processed information complies with one or more protection policies with respect to the second communication network.

2. The apparatus of claim 1,
wherein the data is collected in response to a request from the entity of the second communication network.

3. The apparatus of claim 1, wherein the obtaining the processed information comprises at least one out of the following:
pre-processing content of the data;
aggregating content of the data;
applying one or more protection policies with respect to the second communication network to content of the data;
filtering content of the data;
anonymizing content of the data;
restricting content of the data; and
blocking the data or parts of the data.

4. The apparatus of claim 3, wherein the one or more protection policies are associated with at least one of out of the following:
a type of a network function of the second communication network,
a type of a network function of the first communication network,
an identity of the first communication network, and
an identity of the second communication network.

5. The apparatus claim 1, wherein the at least one memory and the computer program code are configured to, with the at least one processor, cause the apparatus to further perform:
transmitting the processed information to the entity of the second communication network.

6. The apparatus of claim 1, wherein the collecting the data comprises at least one out of the following:
accessing the data from network functions of the first communication network;
accessing the data from an operation, administration and maintenance entity of the first communication network;
accessing the data from application functions of the first communication network;
accessing the data from data collection coordination functions of the first communication network;
accessing the data from data lakes or external storage of the first communication network; and
accessing the data from one or more user equipments served by the first communication network.

7. The apparatus of claim 1, wherein the at least one memory and the computer program code are configured to, with the at least one processor, further cause the apparatus to perform:
registering the apparatus, as performing the data retrieval service, in an authorization entity of the first communication network, wherein the authorization entity is configured to indicate to the entity of the second communication network to direct or send a request for collecting, for the at least one user equipment, data from the first communication network, to the apparatus.

8. The apparatus of claim 7, wherein the registering comprises indicating events which are supported by the data retrieval service.

9. The apparatus claim 1, wherein the at least one user equipment comprises at least one out of the following:
one or more user equipments that are visiting the first communication network; and
one or more user equipments of a specific communication network.

10. The apparatus of claim 1, wherein the collecting the data comprises at least one out of the following:
subscribing to at least one network function of the first communication network; and
contacting at least one network function of the first communication network.

11. The apparatus of claim 1, wherein
the apparatus is part of an entity of the first communication network, which implements the first analytics function, or
the apparatus is part of at least one entity of the first communication network, which implements at least one of network function and proxy function.

12. (canceled)

13. A method of performing a data retrieval service for a first analytics function of a first communication network, the method comprising:
collecting, for at least one user equipment, data from the first communication network;
obtaining, from the data, processed information which is to be passed to an entity of a second communication network; and
storing the processed information,
wherein the processed information complies with one or more protection policies with respect to the second communication network.

14. The method of claim 13,
wherein the data is collected in response to a request from the entity of the second communication network.

15. The method of claim 13, wherein the obtaining the processed information comprises at least one out of the following:
pre-processing content of the data;
aggregating content of the data;
applying one or more protection policies with respect to the second communication network to content of the data;
filtering content of the data;
anonymizing content of the data;
restricting content of the data; and
blocking the data.

16. The method of claim 15, wherein the one or more protection policies are associated with at least one out of the following;
a type of a network function of the second communication network,
a type of a network function of the first communication network,
an identity of the first communication network, and
an identity of the second communication network.

17. The method of claim 13, further comprising:
transmitting the processed information to the entity of the second communication network.

18. The method of claim 13, wherein the collecting of the data comprises at least one out of the following:
accessing the data from network functions of the first communication network;
accessing the data from an operation, administration and maintenance entity of the first communication network;
accessing the data from application functions of the first communication network;
accessing the data from data collection coordination functions of the first communication network;
accessing the data from data lakes or external storage of the first communication network; and
accessing the data from one or more user equipments served by the first communication network.

19. The method of claim 13, further comprising:
registering an entity performing the data retrieval service in an authorization entity of the first communication network, wherein the authorization entity indicates to the entity of the second communication network to direct or send a request for collecting, for the at least one user equipment, data from the first communication network, to the entity performing the data retrieval service.

20.-21. (canceled)

22. The method of claim 13, wherein the collecting the data comprises at least one of:
subscribing to at least one network function of the first communication network; and
contacting at least one network function of the first communication network.

23. (canceled)

24. A non-transitory computer-readable storage medium storing computer-readable instructions for a data retrieval service for a first analytics function of a first communication network that, when executed by a computer, causes the computer to perform:
collecting, for at least one user equipment, data from the first communication network;
obtaining, from the data, processed information which is to be passed to an entity of a second communication network; and
storing the processed information,
wherein the processed information complies with one or more protection policies with respect to the second communication network.

25. (canceled)
